(19) United States
(12) Patent Application Publication
(10) Pub. No.: US 2012/0119007 A1
(43) Pub. Date: May 17, 2012

(54) METHOD FOR COATING A WEAR PART, USE OF A WEAR PART COATED ACCORDING TO THE METHOD, WEAR PART AND REFINER

(75) Inventor: Marke Kallio, Ruutana (FI)

(73) Assignee: METSO MINERALS, INC., Helsinki (FI)

(21) Appl. No.: 13/376,091

(22) PCT Filed: Jun. 1, 2010
(86) PCT No.: PCT/FI2010/050446

§ 371 Date: Jan. 26, 2012

(30) Foreign Application Priority Data
Jun. 5, 2009 (FI) 20095633

(51) Int. Cl. B02C 18/00; B05D 5/08

(52) U.S. Cl. 241/291; 427/372.2

(57) ABSTRACT

The invention relates to a method for coating a wear part, the use of a wear part coated according to the method, a wear part and a refiner. According to the invention, at least part of the wear part surface is treated with an organic-inorganic sol-gel material, and the surface is hardened.

### FIELD OF THE INVENTION

The invention relates to the coating of metallic wear parts. In particular, the invention relates to the coating of wear parts for use in processing a fiber pulp mixture, in order to prevent fouling and clogging.

### BACKGROUND OF THE INVENTION

The blades of high consistency refiners, low consistency refiners, fiberboard refiners and dispersers can be formed from two or more cast or welded bodies facing each other and having a rotationally symmetrical plate, cylinder or cone shape, or combinations of these blade shapes. Optionally, these blades can be composed of smaller parts, like segments of a circular cone or a cylinder combined to form a rotationally symmetrical blade surface. The blades are fixed to a conical or flat body e.g. by means of bolts.

In this context, “blade element” refers to e.g. a blade, partial blade or a corresponding part of a refiner, fiber board refiner, disperser or defibrating apparatus. In the case a blade consists of several parts, the expression blade segment or blade section may be used for these parts.

Wood fiber pulp is treated in a disperser for separating pulp impurities without, how-ever, damaging the fiber during this treatment. A disperser has blade surfaces pro-vided with opposing blades. One blade surface together with its support (the stator) is fixed and the other blade surface with its support (the rotor) rotates relative to the other. The blades and the gaps between them cause an oscillating movement in the pulp within the disperser, whereby the separation of impurities from the fiber takes place. The objective for dispersing is usually to mechanically detach impurities from the pulp and simultaneously refine the impurities into smaller particles without negatively influencing the pulp properties.

The opposing surfaces of refiners and dispersers are formed from bars and grooves. The refiner surface of the blades is usually made up of bars and grooves forming intricate geometrical patterns, the shape of which is dependent on the refining process and the properties of the substrate material. The pulp suspension or the chips fed between the refiner blades during refining is guided between and across the refiner blades to the opposite edge relative to the infeed edge, and further in the process.

Refiner blades are presently manufactured from low, middle and high carbon steel alloys by casting or welding. For example martensitic stainless steel having various amounts of carbon may be used. Such materials are hard and corrosion resistant.

In high consistency or HC refiners, a large blade gap, i.e. a large distance between blade surfaces is used, as well as a high pulp consistency. For this reason, more energy is used in HC refiners than in low consistency or LC refiners, leading to a large amount of steam being generated, causing a greater demand for space than the refining process in a LC refiner which is carried out in the water phase and at lower consistency. The rotational speed of the refiner surfaces in HC refiners is also greater than that of LC refiner surfaces. Consequently, the greater peripheral velocity of an HC refiner surface relative to that of an LC refiner surface affects the refining process in the sense that the fiber material is subjected to a greater amount of defibrating impacts in HC refining than in LC refining. Partly for this reason, more load can be put on an HC refiner than on an LC refiner. A higher load means high power consumption, a high generation of steam and further the need for a substantial volume flow. In addition, due to the great peripheral velocity of an HC refiner, the fibers tend to pack into the grooves of the refiner surface, causing clogging. The components of the refined material (e.g. pitch) may also under certain circumstances start to agglomerate in the refiner blade grooves. In LC refining, clogging is correspondingly caused by the separation of fiber and water, the fibers packing into the refiner blade grooves.

The refiner blades are subjected to problems appearing in a continuous process. The service life of the blades should be extended in order to decrease the costs of the refining process.

When diluted compositions are refined, the refiner must in particular satisfy the following three criteria: Optimal fiber treatment, optimal capacity and the strength or breakage resistance of the structure.

Refiner blades are subjected to continuous abrasion during use. During refining, the blades are purposefully driven against each other to enhance the refining of the material being processed between refiner blade surfaces. The service life of the blades is also reduced by foreign particles entering the blade gap, like sand, glass and metals, or paper filler materials.

The wear mechanism of refiner blades may be complicated. Blade failure processes in addition to breaking are e.g. abrasion, corrosion, cavitational erosion, solid and liquid particle impingement and fatigue. The overlap and concurrency of various wear processes makes it difficult to assess what process is dominating in each case. Certain wear processes like serration, pitting, and blade edge rounding are particularly typical when refiner blades are concerned.

In many applications, the main wear mechanism of refiner blades is the corrosion-enhanced abrasion in water based pulps. In a dry process the maximum service temperature is about 170-180° C. and in a wet process about 70-80° C. In fiberboard refiners, the temperature may also exceed 200° C. The temperature may rise locally higher due to friction. Steam can also be present in a refining process. Hard materials like glass or metal particles may cause mechanical damage to the blades.

During service, wear of the refiner blades and rounding of the edges occur. It is essential for the pulp quality that the blade bar edges remain sharp, since the main part of the work takes place at the leading edges of the blade bars as they pass each other. Blades having rounded edges produce inferior quality pulp and use more energy than blades having sharp bar edges.

Several technologies are known in the art for increasing the hardness of refiner blades. These technologies are based on e.g. coating or diffusion treatment like carbonization, and their purpose is to increase the surface hardness relative to that of the matrix material. One solution disclosed in the state of the art is to modify the blade edges or the whole surface to provide a thin, hard layer which keeps the edges sharp throughout the service life of the blade. A thin, hard surface preserves the sharp edge if the inner blade material is softer. A hard coating, however, works only as long as it stays intact during the refining process.

In publication EP 1 507 023 A1 is disclosed a planar refiner blade having provided on its surface a wear resistant layer formed by ion implantation.

In publication U.S. Pat. No. 4,061,283 is disclosed a refiner in which the leading edges of the teeth on the rotor and stator have been treated with a hard coating. Diffusion methods such as carbonization, boronization, vanadization and nitration are presented as suitable coating processes.

Another significant problem increasing the need for blade replacement is the clogging and fouling of the blade flow channels, i.e. the grooves between the blade bars. The thin and hard coatings used according to the state of the art are equally sensitive to fouling as an untreated steel surface, i.e. hard coating treatments are of no use from the viewpoint of fouling prevention. In high consistency refiners the pulp water con-tent is low and due to service temperatures rising to even 170-180° C., the pulp may locally char and stick to the flow channels. Also additives used in recycled paper pulp, like inorganic fillers and pigments, may form impurities which stick to the flow channel surfaces. When flow channels are blocked, the process quality suffers, energy consumption rises and the blades must be replaced prematurely because of fouling. Blade replacement causes additional interruptions to the process.

The fouling process may for example be such that organic material adheres to the oxide layer of a metal surface, and/or, the pH being suitable, fillers precipitate on the metal surface and sticks. The oxide layer normally occurring on the metal surface is typically hydrophilic, i.e. water wets the surface and spreads. The precipitates may agglomerate and grow larger over time.

The fouling in the flow channels may form hard agglomerates and lumps which come loose during the process and thus increase the wear of the blades and their possible wear resistant coating.

The fouling problem is acknowledged in the art and solutions have been proposed, e.g. the modification of flow channel geometry and mechanical polishing of the blade bars and/or grooves. Merely changing the channel geometry does not lead to a satisfactory result. Polishing again is a work-intensive and fairly expensive method, in particular if the distances between bars are very small.

In the publication U.S. Pat. No. 5,868,330 a white cast iron refiner blade plate is disclosed, where the upper surfaces or the leading edges of blade bars are provided with grooves which are filled with material including wear resistant grains. The purpose is to pro-vide local rough areas on the blade bars to retain the fibers during refining. The roughness is achieved either through normal wear or through etching. In order to avoid simultaneous roughing of the flow channels, the channel surfaces are treated with a wear and corrosion resistant metal, paint or polymer material.

In the publication U.S. Pat. No. 5,868,330, the roughness problem of the channels is solved by coating the channel surfaces with a wear resistant coating, keeping the surfaces smooth. The publication does not discuss the clogging problem caused by channel surface fouling and impurities adhering to the surfaces, which problem is present also in the case of smooth metal surfaces.

In refiners, the blades are attached to the refiner blade support body. The support body may include various brackets or clamping plates. During use, pulp and impurities collect on the support body surfaces, causing to a need for cleaning. The necessary cleaning of the support body leads to wear of the body, dimensional deviations, problems in attaching blades and even blade detachment may follow.

Screening cylinders are used e.g. in the cleaning and classification of fiber pulp mixtures. A screening cylinder can be manufactured e.g. by attaching parallel mesh wires adjacently in a cylindrical shape so as to leave between them screen slots of a required dimension. The mesh wires form the screen- or classifier surface of the screen cylinder. The screen cylinder may also be manufactured in such a manner that a perforated surface acts as the screen surface, the apertures forming the screen slots.

When the screen is in operation, the liquid in the fiber pulp mixture and the part of the fibers determined by the slit size flows through the apertures or slits in the screen surface from the feed side or feed compartment to the screen cylinder accept side or accept compartment, and shives, oversize fibers, fiber bundles and other separated material remain on the screen cylinder feed side, to be discharged from the screen as reject. Depending on the application, the screen cylinder may be arranged with its accept side either on the inside or the outside of the cylinder.

For the ideal operation of a screen cylinder it would be important that the aperture or slit size would remain unchanged and the screen cylinder would remain clean during classifying service. However, the fiber suspension processed by classifiers contain several agents with a tendency to thicken and adhere to the screen basket. Examples of agents prone to adhere to the screen basket are slime formed by bacteria, fungus mycelium, bleaching agent residues, calcium oxalates, calcium carbonates, barium sulfate and extracts like pitch and fatty acid soaps. Such agents may collect on the screen basket surface or come loose as enlarged lumps, visible as defects in the final fiber web. Sometimes, the agents remain on the screen basket surface until cleaning, whereby they block the screen basket slits and lower the capacity of the apparatus. Such agents may stick tightly to the screen basket surface whereby cleaning of the screen basket is difficult and requires much time. Another problem is the enlargement of classifier apertures or slits due to wear. For example, the classification of recycled fiber material may wear out the screen basket relatively quickly because of the sand, glass or metal particles contained therein. In this case, the accept quality decreases as ever larger material passes through the screen cylinder.

Screen wires are usually manufactured from austenitic stainless steel. According to the state of the art, screen wires are often coated using electrolytical hard chromium plating. Chromium plating methods are an environmental burden.

According to the invention, it has been observed that the above-described fouling and clogging problems in wear parts used in the processing of fiber pulp can be solved by coating the wear part with an organic-inorganic, fouling-preventing sol-gel material.

According to a preferable embodiment of the invention, a truly functional surface is provided in refiner blades, simultaneously preventing both blade bar rounding and surface fouling.

In screen cylinders, the invention makes possible the replacement of hard chromium plating by a combination of diffusion coating and sol-gel coating.

Sol-gel coatings, as well as various techniques for forming sol-gel coatings are known in the art. Sol-gel materials can be applied for coating e.g. metal, ceramic, wood, wood composite or concrete surfaces. In the preparation of sol-gel coatings, liquid-based starting materials are used and organic and inorganic components are combined at the molecular level so, that no macroscopic phase boundaries remain in the coating, such boundaries being typical for traditional composite coatings; instead, a nanoscale network structure is formed in the material. The liquid phase starting materials are crosslinked and hardened using hydrolysis and polycondensation reactions. The removal of solvents and the final hardening of the coating may be carried out e.g. by means of heat.

In the publication WO 2008/155453, the coating of a painted surface with sol-gel material is disclosed.

Fouling-preventing sol-gel coatings have not previously been used for coating wear parts like refiner blades. In this implementation, many advantages can be gained by the use of sol-gel coating.

In refiners, blade fouling is often a reason for blade replacement though the wear has not yet proceeded very far. As the gaps between blade bars fill with contamination, the process is disturbed and the energy consumption increases. If the first stage of fouling is prevented with a non-stick surface, blade life is significantly extended.

The thin, hard coating or surface treatment used according to the prior art keeps the blade edge sharp. Wear of the hard coating may occur in such a manner that material adheres to the surface and the lumps so formed peel off, stripping surface material in the process. These hardened lumps whirl between the blades causing additional wear. An anti-fouling surface according to the invention, applied to the hard coating, not only keeps the surface clean but also extends the service life of the hard coating underneath. An object of the present invention is to simultaneously both improve the function of the hard coating, slowing the rounding of the blade bar edges, and prevent the clogging of channels, avoiding premature blade exchange.

Also the corrosion of the metal surface accelerates the wear of a wear part. The sol-gel coating of the present invention slows the effect of corrosion and thus slows wear.

The anti-fouling coating according to the invention may be applied without an under-lying hard surface, Thereby it mainly prevents the fouling of the wear part.

The invention may also be used to protect the wear part surface from oxidation. In contact with air, a thin protective oxide layer is usually formed on a metal surface. If the protective oxide layer is damaged, the metal surface begins to oxidize, or rust, in an aqueous environment. This may occur also in stainless, martensitic steels, in which a large part of the chromium occurs in carbide form.

Advantages of the invention are, that the service life of the wear part is extended; energy costs can be decreased; the processed pulp moves better; and there are less process quality fluctuations.

The coating method according to the invention can be applied to the surface of a wear part formed from steel by casting or in other ways, and it may be hard coated e.g. using a diffusion method. The method according to the invention does not require high temperatures. The final coating resists temperatures of even 300° C., and it may be used in damp conditions, and in the pH ranges occurring in refiners, dispersers, defibrators and classifiers.

Use of the invention provides improvements both relative to uncoated wear parts and to wear parts which have only been hard coated. In the latter case, the coating according to the invention also improves the functionality of the hard coating according to the prior art.

### DISCLOSURE OF THE INVENTION

The invention relates to a method for coating a metallic wear part, in which method at least part of the surface of the wear part is treated with an organic-inorganic sol-gel material to form a first layer, and the layer is hardened. According to the invention, the metallic wear part is one of the following: A refiner blade, a support body for a refiner blade, a disperser blade, a defibrator blade, a screen basket or a part of any of the aforementioned.

According to an embodiment of the invention, the surface coated with a sol-gel material is heat treated.

According to an embodiment of the invention, a second layer is formed on at least part of the wear part prior to the treatment with sol-gel material, the hardness of which second layer is greater than the material beneath the second layer.

A further subject of the invention is the use of a wear part coated according to the invention in mechanical pulp refiners, low consistency refiners, fiberboard refiners, medium consistency refiners, dispersers and defibrators.

A further subject of the invention is a wear part for use in refiners for the refining of fiber pulp, which wear part is a refiner blade element comprising several blade bars on the refining surface of the refiner blade element, each blade bar comprising a top surface and side surfaces; several grooves, each being formed between two adjacent blade bars, said wear part being characterized in that at least part of the surfaces of the blade bars and/or grooves is coated with a first layer comprising organic-inorganic sol-gel material.

According to an embodiment of the invention, on at least part of the surfaces of the blade bars and/or grooves have beneath the first layer a second layer, the hardness of which is greater than the hardness of the material underneath the second layer.

Further, a subject of the invention is a wear part for the purification and classification of a fiber pulp mixture, which wear part is a screen cylinder comprising a screen surface having screen slits which are adapted to guide part of the fiber pulp mixture fed to the feed side of the screen cylinder to the accept side of the screen cylinder, the wear part being characterized in at least part of the surfaces of the feed side of the screen surface and of the screen slit surfaces is coated with a first layer which comprises organic-inorganic sol-gel material.

According to an embodiment of the invention, at least part of the surfaces of the accept side of the screen surface is further coated with a first layer which comprises organic-inorganic sol-gel material.

According to an embodiment of the invention, on at least part of the screen surface under the first layer there is a second layer the hardness of which is greater than the hardness of the material beneath the second layer.

According to an embodiment of the invention, the width of the screen slits is 0.1 mm to 0.5 mm.

According to an embodiment of the invention, the organic-inorganic sol-gel material of the first layer comprises organic material and ceramic material, and the proportion of said organic material of the total mass of the sol-gel material is 25-50% following heat treatment.

According to an embodiment of the invention, the second layer is formed by diffusion coating technology.

### BRIEF DESCRIPTION OF THE DRAWINGS

The invention is disclosed below in further detail in an exemplary manner with reference to the appended drawings, of which:

FIGS. 1A and 1B show an example of a stator and a rotor, respectively, of a disperser, as well as examples of conical refiner blade element as used therein;

FIG. 2 shows an example of a plane view of a refiner blade element;

FIGS. 3A and 3B show sections of a refiner blade segment coated using a method according to an embodiment of the present invention;

FIG. 4 is a schematical view of a prior art screen cylinder and an end view of a screen wire;

FIG. 5 is a schematical view of the basic structure of a prior art screen cylinder, as a section along the screen cylinder axis.

### DETAILED DESCRIPTION

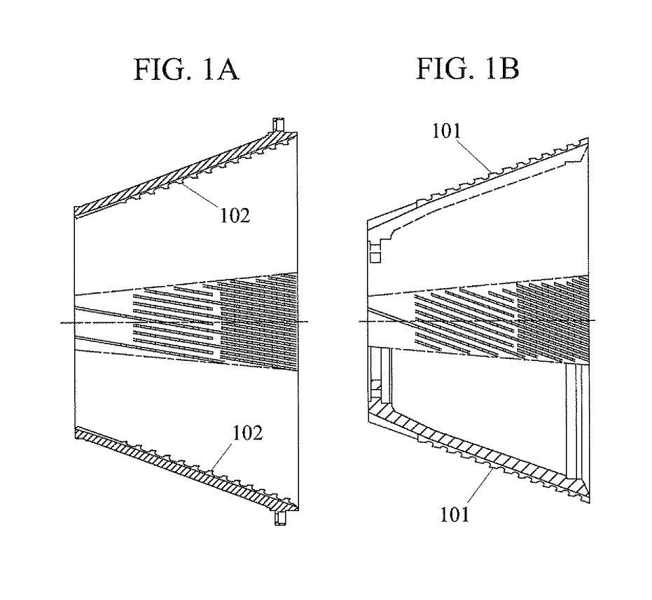

FIGS. 1A and 1B show the stator and the rotor, respectively, of a disperser, as well as examples of conical refiner blade elements used therein. The stator and the rotor are shown as sections. The first refiner surface, i.e. blade surface 101 is situated in the rotating rotor of a refiner, disperser or defibrator and the second refiner surface is situated in the fixed stator of the refiner, disperser or defibrator. The refiner surfaces may be formed directly as part of the stator/rotor or they made be formed as separate blade segments or blade sections in a manner known in the art. The refiner surface comprises blade bars and grooves between these.

The refiner blade element may be shaped as a plate, cylinder, cone, a partial planar surface, a partial cylinder surface, a partial conical surface or any combination of these.

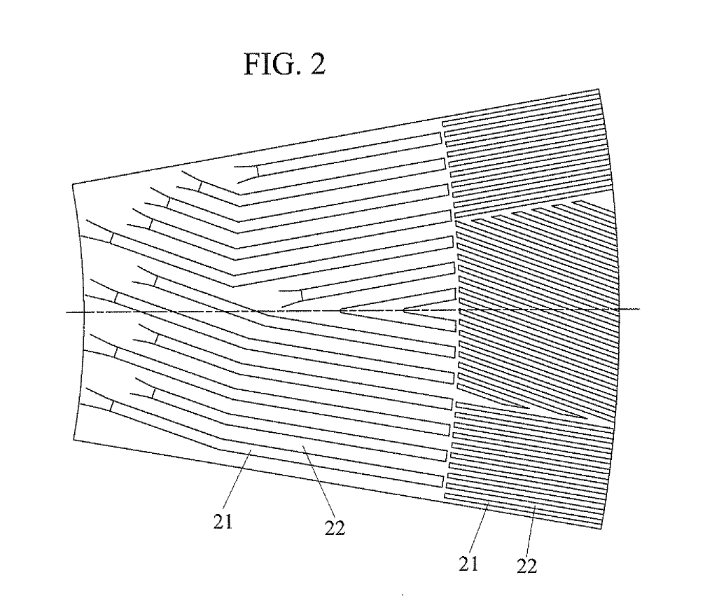

FIG. 2 shows a planar view of an example of a plate-shaped refiner blade element. On the blade element surface are provided several blade bars 21 and several grooves 22.

The geometrical situation of the blade element bars and grooves are dependent on the relevant application. The surface of the blade element in FIG. 2 is divided into several partitions in which various different patterns have been used.

According to the invention, the width of blade bars 21 may be about 0.5-about 7 mm, preferably about 0.5-about 3 mm. According to the invention, the width of grooves 22 may be about 0.5 mm-about 11 mm, preferably about 0.5-4 mm, more preferably about 0.5-about 2 mm. Due to the invention, the blade bars and blade grooves used may be narrower than normally.

In fiberboard refiners, larger groove widths are often used e.g. for avoiding pitch adherence, such that the groove width may be for example about 8 mm. The width of fiberboard refiner blade bars are typical also for other refiners, e.g. about 3 mm.

Various different groove widths may also be used in refiners, the blade surface thus having first, wider grooves for feeding substrate material and discharging refined material as well as steam generated in the course of the refining process. The second grooves in a refiner surface of this type are narrower, forming the main refiner surface together with the adjoining blade bars. The second grooves may have been formed also into the wide blade bars or ridges between wider grooves, at an angle relative to the wider grooves, the narrow grooves forming channels between wide grooves. The width of these narrower grooves corresponds to that of the typical refiner grooves referred to above.

The widths of blade bars and grooves of dispersers and defibrators are often larger than those of refiner blade bars and grooves.

The blade bars of blade elements and the grooves inbetween may be e.g. radially oriented, at some angle relative to the radius, or they may run as curves across the blade surface. The blade bar may extend unbroken across the whole blade surface, or it may consist of shorter portions or of tooth-like very short portions. FIG. 2 shows an example of a blade segment of a circular disc blade. The blade segment of FIG. 2 has three main zones: the outer zone, the middle zone and the inner zone. At the edges of the outer zone, closest to the side surfaces of the blade segment, the blade bars and the intervening grooves are oriented along the blade segment radius. The blade bars at the middle of the outer zone are oriented parallel at an angle of about 10 degrees to the radius. In the middle zone, the blade bars and the intervening grooves are oriented in two directions relative to the radial direction in order to form a V shape. In the inner zone, the blade bars and the intervening grooves are oriented in a single direction relative to the radial direction. The radial direction is the direction from the blade segment feed edge to the discharge edge:

The blade bar widths, the groove widths and the blade bar angles are selected according to the relevant application. Factors influencing the selection are e.g. the material to be processed, the processing conditions like humidity, temperature and pressure, and the required refining, dispersing or defibrating effect. The greatest benefit of a solution according to the invention is gained in blade applications where there is a tendency for fouling or clogging of the blade surfaces. Examples are narrow grooves, groove orientations resulting in slow flow, tightly packed blade designs or fouling process conditions. On the other hand, since the flow friction of surfaces treated according to the invention with a sol-gel coating decreases, it is basically possible to increase the capacity in all refiner, disperser and defibrator applications. Moreover, as diffusion technology is used to apply a coating improving the hardness of the steel surface prior to the sol-gel coating, a significant increase in the service life of blade surfaces can be obtained even in severely abrasive conditions.

The blade bar and/or groove surfaces may be wholly or partly coated using a method according to the invention. For example, treatment of only the groove surfaces can be undertaken. A preferable coating application comprises the coating of one or more zones of a refiner blade assembly segment, for example in the case of FIG. 2 the outer blade zone. This application is preferable due to the easy clogging of the narrower grooves at the outer periphery of the blade disc. The invention can also be so applied, that only part of the refiner blade elements, for example every second, is coated according to the invention. In some embodiments, blade elements coated in various different manners may be used in the same refiner.

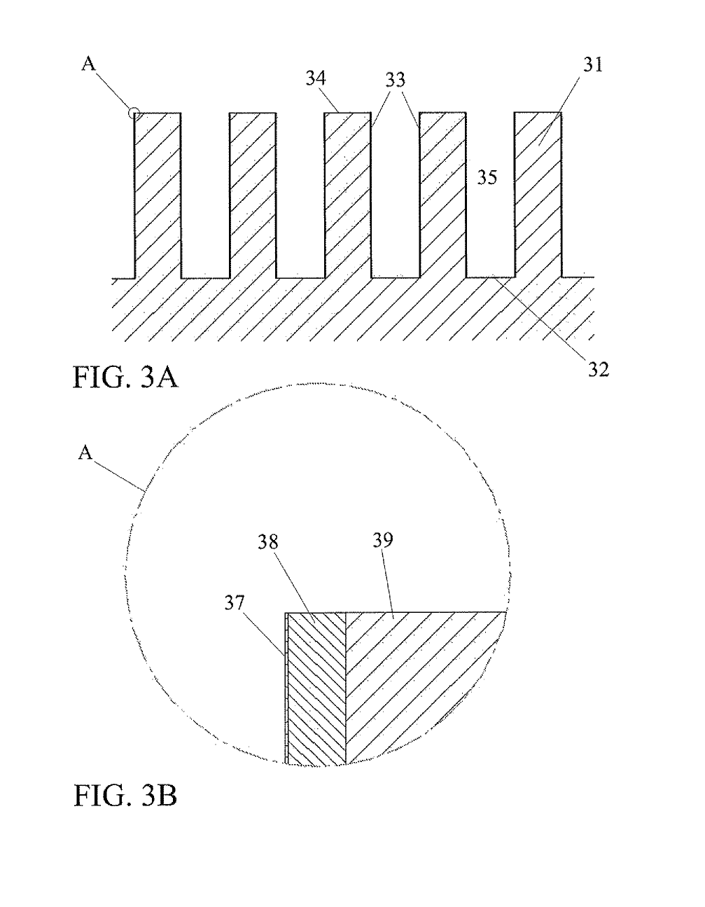

FIGS. 3A and 3B show a section illustrating the relative dimensions of blade bars 31 and grooves 35. In FIG. 3A, five adjacent blade bars 31 are schematically shown. Each blade bar 31 comprises two side surfaces 33 and a top surface 34. In this example, the widths of blade bars and grooves are equal, for example about 2 mm. Each groove is formed from bottom surface 32 between two adjacent blade bars 31 and the side surfaces 33 on both sides of the bottom surface.

FIG. 3B shows a partial enlargement of location A indicated by a circle in FIG. 3A. On the blade bar side surfaces, a first upper layer 37 has been formed, consisting of sol-gel material, and a second lower layer 38 formed using hard coating technology. The hardness of hard coating 38 is greater than the hardness of the blade bar matrix 39. The thickness of first layer 37 may be for example about 1 μm-about 2 μm. The thickness of second layer 38 may be for example about 20 μm-about 40 μm.

A blade bar is often rectangular in section, as in FIG. 3A, or of similar form. A refiner blade bar is often, starting from its free end, rectangular in section for half of its height, being thicker at the root as determined by the clearance angle due to the cast structure. One or more side of the blade bar may also be inclined to provide more efficient guidance of the refined material between the blade bars due to the inclination. Disperser blade bars usually consist of short bars arranged in sequence and in parallel, their shape reminiscent of teeth or shark's fins Defibrator blade bars again are often formed as radially oriented blade bars having one or more steps in the bar direction from the feed edge to the discharge edge. For refiner, disperser and defibrator blade bars and grooves, it is typical that their numbers grow from the feed edge to the discharge edge, and that they are wider at the feed edge and narrower in the blade surface middle area and most narrow at the discharge edge of the blade surface.

The sol-gel coating may wear off the blade bar top surfaces during use, but the coating lasts longer on the blade bar side surfaces and on the groove bottom surfaces, where it prevents the adherence of fouling in the channels.

A further advantage of the anti-fouling sol-gel coating is, that the microtophography and the surface energy of the underlying hard coating change so, that on the micro-scale the hard coating is smoother, chemically more inert and more wear resistant. Thus the blade bar edges stay sharp longer as the blade bar wears only at the top surface where softer material is exposed.

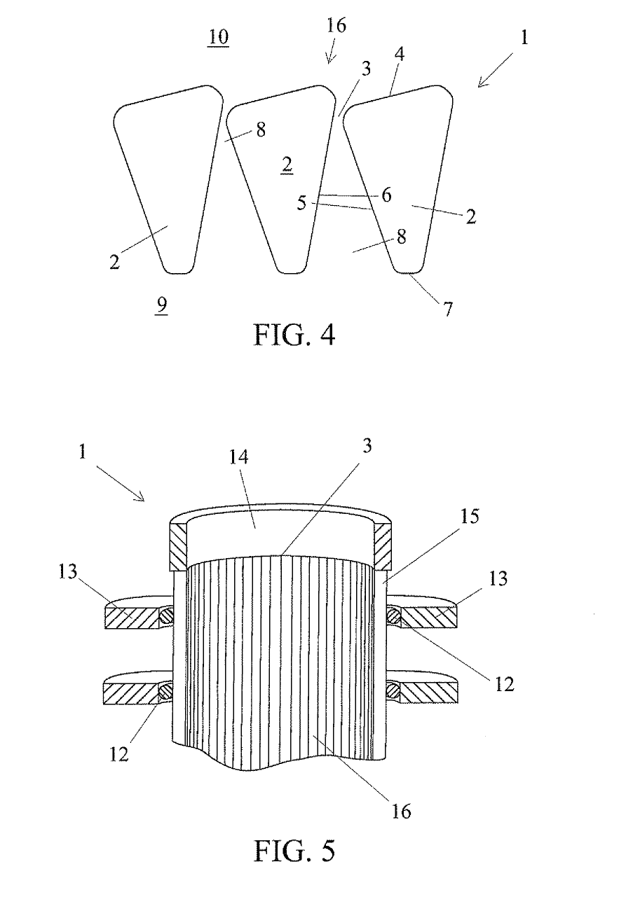

FIG. 4 is a schematic view of a screen cylinder 1 and a screen wire 2 according to the prior art, as seen from the end of screen wire 2. FIG. 4 schematically shows three screen wires 2, adapted adjacently at a relative distance, leaving between them screen slot 3. For clarity, FIG. 4 does not show support wires or support bars, to which screen wires 2 are usually fixed. Screen wires 2 according to FIG. 4 have a feed side surface 4 essentially facing the feed side or feed compartment 10 of screen cylinder 1, first accept channel surface 5, second accept side surface 6, and head surface 7 connecting first accept channel surface 5 to the second surface. As screen wires 2 are arranged adjacently, accept channel 8 is thus formed between accept channel first surface 5 and second surface 6 of screen wires 2, said channel leading from screen slot 3 to the accept side or the accept compartment 9. The feed side surfaces 4 of screen wires 2 thus together form the screen cylinder screen surface or classification surface 16 having screen slits 3 between screen wires 2. In the positioning of screen cylinder 1 shown in FIG. 4, the feed side or the feed compartment 10 of screen cylinder 1 is thus above screen wires 2, and the accept side or the accept compartment 9 of screen cylinder 1 is below screen wires 2.

FIG. 5 is a schematical view of the basic structure of screen cylinder 1 as a section along the direction of the axis of screen cylinder 1. Screen cylinder 1 has screen wires 15 around its whole periphery, to form screen surface or classification surface 16. Between screen wires 15 are screen slits 3, through which the liquid and the required part of the fiber supplied to the feed side of screen cylinder 1, i.e. in this case the inside of screen cylinder 1, are allowed to flow from the feed side 10 of screen cylinder 1 to the accept side 9, i.e. in this case the outside of screen cylinder 1 while pins and oversize fiber, fiber bundles and other separated material remain inside screen cylinder 1 to be discharged as reject. The screen wires 15 are typically fixed to support bars or support wires 12. Support bars 12 are provided at suitable intervals in the direction of the screen cylinder axis so as to fix the screen wires 15 sufficiently rigidly and steadily into place. Support rings 13 may further be mounted around support bars 12 to support the bars 12 and receive forces caused by pressure gradients due to various fluctuating pressures on opposite sides of the screen surface in screen cylinder 1; and thus strengthen the structure of screen cylinder 1. FIG. 5 also shows an end ring 14 mounted at the ends of screen cylinder 1, by means of which screen cylinder 1 can be mounted in the screen frame.

From the viewpoint of cleanliness, the most important issue is the coating treatment of the feed side and the screen slots of the screen basket, or more generally speaking the apertures of the screen basket, for maintaining a high capacity for the screen basket. Keeping the accept side clean is also often desirable for avoiding spinning and fouling, since spinnings and aggregations coming loose may be harmful downstream in the process.

According to a preferable embodiment of the invention, sol-gel treatment is carried out on the screen basket feed side and the screen apertures as well as on the screen basket accept side and the accept side support structures.

According to another preferable embodiment of the invention, sol-gel treatment is carried out only on the screen basket feed side and the screen apertures.

According to a third preferable embodiment of the invention, sol-gel treatment is carried out only on the screen basket feed side and on the screen apertures from the feed side down to the most narrow portion of the apertures, and more preferably further on the screen apertures about ¼ of the distance from the most narrow portion of the screen apertures towards the accept side surface, whereby the passage of the accept past the narrowest portion to the accept side is ensured.

The width of the screen slits or screen apertures of the screen basket may be e.g. about 0.1 mm-about 0.5 mm.

In a screen basket it is preferable to treat the feed side surface and the screen slits against wear, but to treat the accept side against wear is not necessary. According to a preferable embodiment of the invention, the screen basket feed side and the screen slits are subjected to diffusion treatment prior to sol-gel coating.

In the method according to the invention, the surface of a metallic wear part or part of the same is treated with sol-gel material to generate a functional antifouling surface layer.

According to the invention, the material of the wear part may be e.g. steel, like martensitic steel, stainless steel, 17-4 PH steel or duplex, or white cast iron or Ni-hard. According to a preferable embodiment, the surface of the wear part to be treated is essentially in an as-cast state. In this context, a surface essentially in an as-cast state is an unmachined surface directly from the casting operation, to which has possibly been applied a cleaning treatment like steel ball blasting, sand blasting or cleaning by means of abrasive hand tools, and in the case of steel, possibly hardening and annealing.

Prior to treatment with sol-gel material, a thin, hard surface layer may be formed using e.g. braze coating technology or diffusion treatment, like carbonization or nitration.

It has been observed that the adherence of sol-gel coating to surfaces essentially in an as-cast state is good. A diffusion coating treatment does not weaken the adherence of sol-gel coating. The method according to the invention may be applied also to rolled surfaces.

By means of a sol-gel coating, the surface energy of a steel surface is modified to render the surface dirt-repellent in damp conditions. When a surface becomes hydro-phobic, i.e. water repellent, the contact angle of water decreases, whereby the water forms droplets on the surface and causes the pulp to flow more easily. A sol-gel coating also forms a physical barrier for the water at the metal surface, and thus prevents the action of corrosion (paint effect). A sol-gel coating renders the surface smoother on a microscale, which prevents dirt or pulp from sticking mechanically to the surface.

The material of the sol-gel coating comprises a ceramic component and an organic component. The ceramic component may be e.g. an alkoxide of silicon, aluminum or zirconium. The organic component may be e.g. a polymer like polyacrylate, epoxy or the like. The sol-gel may be organically modified, whereby functional groups have been added. One typical sol-gel is an alkoxysilane based, organically modified sol-gel.

The fraction of organic component in a sol-gel may be about 25-about 50%, for example about 25%-about 30% or about 40%-about 45%. As the fraction of organic component increases, the coating thickness increases but the hardness and thermal stability decrease.

In addition to the ceramic and organic components, a sol-gel usually contains a small amount of acid for controlling the pH, for example about 1%-about 2%. The acid may be for example hydrochloric acid. As a solvent in sol-gels, water and alcohol may be used.

The thickness of a sol-gel layer according to the invention may vary according to the composition and manner of applying. The thickness of the sol-gel layer can be chosen for example in the range 1-about 40 μm, preferably less than 10 μm. According to one embodiment of the invention, the thickness of the sol-gel layer may be less than 1 μm.

For applying the sol-gel coating, any suitable wet coating technology may be used, for example spraying manually or using a robot, brushing, rolling, dipping or brush spreading, preferably spraying or manual spreading.

The viscosity of a sol-gel solution is so low, that the spraying of the subject surface may be carried out in a vertical position, whereby the surplus liquid runs off. The low viscosity makes possible also the coating of narrow and deep grooves, which is challenging when using e.g. Teflon coatings.

In forming the hard coating, any suitable coating method or diffusion coating technique may be used, for example carbonization or nitration. The technology used for forming the hard coating is selected according to the subject application, for example taking into account the dimensions and the material of the object. When diffusion coating techniques are used, the hard layer is formed beneath the surface, within the material, and thus it does not increase the material thickness. In this case, the blade geometry (groove width and blade thickness) does not change.

The hardening of the sol-gel coating and solvent removal can be carried out using heat treatment and/or UV radiation. The temperature during heat treatment may be for example about 80° C.-about 250° C., preferably about 100° C.-about 150° C. The purpose of the heat treatment is, i.a. to remove solvent from the coating. During drying of the sol-gel coating, hydrolysis and polycondensation reactions occur. In the standard sol-gel method, silicon alkoxide is hydrolyzed, whereafter polycondensation takes place due to polar solvents (water, alcohol). In an acid environment, a siloxane (O—Si—O) network nanostructure is formed, whereas a basic environment leads to separation of nanoparticles in the coating. During heat treatment, the final polymerization of the coating may also be effected.

The invention is suitable for the coating of wear parts used in the handling of low, medium and high consistency pulps, like refiner blades, blade support surfaces, disperser blades and screen cylinders. Typically, in low consistency refiners the pulp consistency is 2-8%, in high consistency refiners and dispersers 20-60%, and in medium consistency refiners and fiberboard refiners the consistency is often in the area between these. All such refining applications as fiberboard production and paper pulp refining in mechanical and chemimechanical pulp production are considered high consistency refining Medium consistency refining naturally includes refiners as well as defibrators used for treating fiber in the water phase. In classifiers, the consistency is typically in the range 0.5-8%. The water content is a factor influencing the functionality of the solution according to the invention in the sense that the solution works better the higher is the water content in the process.

The fouling-preventing sol-gel coating according to the invention works best in aqueous conditions. The invention may be applied also in damp conditions with occasional occurrence of steam.

The invention is, however, not limited to the applications disclosed above, but other possible fields of application are e.g. corresponding dynamic, aqueous applications in which clogging or fouling is a problem.

1-25. (canceled)

26. A method for the coating of a wear part for use in the treatment of a pulp mixture, said wear part selected from the group consisting of a refiner blade, a refiner blade support body, a disperser blade, a defibrator blade, a screen basket and a part of these; in which method at least part of the wear part surface is rendered hydrophobic by treating it with an organic-inorganic sol-gel material to form a first layer; and by hardening the layer.

27. The method according to claim 26, wherein the hardening is effected by heat treatment.

28. The method according to claim 26, wherein the organic-inorganic sol-gel material of the first layer comprises organic material and ceramic material, and the fraction of said organic material of the total mass of the sol-gel material is 25-50% following hardening.

29. The method according to claim 26, wherein further, prior to the treatment with sol-gel material, a second layer is formed on at least part of the wear part surface, the hardness of which is greater than the hardness of the material beneath the second layer.

30. The method according to claim 29, wherein the second layer is formed using diffusion coating technology.

31. A wear part for use in the treatment of a pulp mixture,
wherein
on at least part of the wear part surface there is a first layer comprising organic-inorganic sol-gel material, said first layer rendering said part of the surface hydrophobic.

32. The wear part of claim 31, said wear part being a refiner blade element for refining pulp mixtures, comprising:
several blade bars on the refiner blade element refining surface, each blade bar comprising a top surface and side surfaces;
several grooves, each formed between two adjacent blade bars;
wherein on at least part of the surfaces of the blade bars and/or grooves there is a first layer comprising organic-inorganic sol-gel material, said first layer rendering said part of the surfaces hydrophobic.

33. The wear part of claim 31, said wear part being a screen cylinder for the purification and classification of a fiber pulp mixture and having a screen surface comprising screen slits adapted for conducting part of the fiber pulp mixture fed to the feed side of the screen cylinder to the accept side of the screen cylinder,
wherein on at least part of the surfaces of the screen surface feed side and the screen slit surfaces there is a first layer comprising organic-inorganic sol-gel material, said first layer rendering said part of the surfaces hydrophobic.

34. The wear part according to claim 33, wherein on at least part of the surfaces of the screen surface accept side there is also a first layer comprising organic-inorganic sol-gel material, said first layer rendering said part of the surfaces hydrophobic.

35. The wear part according to claim 31, wherein the organic-inorganic material of the first layer comprises organic material and ceramic material, and the fraction of said organic material of the total mass of the sol-gel material is 25-50% after hardening.

36. The wear part according to claim 32, wherein on at least part of the surfaces of the blade bars and grooves, beneath the first layer there is a second layer the hardness of which is greater than the hardness of the material beneath the second layer.

37. The wear part according to claim 33, wherein on at least part of the screen surface, beneath the first layer is a second layer, the hardness of which is greater than the hardness of the material beneath the second layer.

38. The wear part according to claim 36, wherein the second layer is prepared using diffusion coating technology.

39. The wear part according to claim 32, wherein the width of the blade bars is 0.5 mm-7 mm.

40. The wear part according to claim 32, wherein the width of the blade bars is 0.5 mm-3 mm.

41. The wear part according to claim 32, wherein the width of the grooves is 0.5 mm-11 mm.

42. The wear part according to claim 32, wherein the width of the grooves is 0.5 mm-4 mm.

43. The wear part according to claim 32, wherein the width of the grooves is 0.5 mm-2 mm.

44. A refiner for refining fiber pulp, wherein it comprises at least one wear part according to claim 32.

45. The wear part according to claim 33, wherein the width of the screen slits is 0.1 mm-0.5 mm.

46. The wear part according to claim 37, wherein the second layer is prepared using diffusion coating technology.
